(19) United States
(12) Patent Application Publication
(10) Pub. No.: US 2026/0318021 A1
(43) Pub. Date: Oct. 15, 2026

(54) A BIOLOGICAL WASTE COLLECTION DEVICE AND ASSOCIATED METHOD

(71) Applicant: Charlotte McMullen, London (GB)

(72) Inventor: Charlotte McMullen, London (GB)

(21) Appl. No.: 19/106,558

(22) PCT Filed: Aug. 24, 2023
(86) PCT No.: PCT/GB2023/052204

§ 371 Date: Feb. 25, 2025

(30) Foreign Application Priority Data
Aug. 26, 2022 (GB) 2212463.0

(51) Int. Cl. E01H 1/00; B65F 1/00

(52) U.S. Cl. CPC E01H 1/006; B65F 1/0006; B65F 2210/102; B65F 2240/136

(57) ABSTRACT

Please replace the abstract as originally filed with the below amended Abstract: According to the present invention, there is provided a biological waste collection device. The device comprising a primary pliantly-flexible appendage receiver for receiving grasping means and a secondary pliantly-flexible appendage receiver. The secondary pliantly-flexible appendage receiver is arranged in an inverted and reversed relationship relative to the primary pliantly-flexible appendage receiver about a hinge that extends along the width of the primary pliantly-flexible appendage receiver. The arrangement is such that the secondary pliantly-flexible appendage receiver can be pivoted over the primary pliantly-flexible appendage receiver to secondarily enclose the biological waste.

The present invention relates to a biological waste collection device, particularly but not exclusively for the collection of pet faeces. The invention also relates to a method of collecting biological waste, preferably using such a biological waste collection device according to the present invention.

Dog faeces are an eyesore and a health hazard. In severe cases, contact with dog faeces can cause infection that can lead to loss of vision. Therefore, it is no surprise that owners can face fines of up to £1,000 in the U.K. for failing to clean up after their pet, enforceable under the Anti-Social Behaviour, Crime and Policing Act 2014.

There are a number of current solutions on the market that allow dog owners to collect faeces ready for disposal. The most popular of which, is a simple plastic bag that the owner uses to cover their hand, allowing the faeces to be grasped, before the bag is inverted over the grasped faeces and latterly tied off. There are a number of limitations with using such a bag. Firstly, it is generally advised to double-bag dog faeces, and the popular aforementioned plastic bag solution does not lend itself to this. Owners want to make their store of bags last as long as possible, as well as the general drive to reduce the consumption of single-use plastics. Secondly, the plastic bags are often very thin, affording the owner an unpleasant sensation. The unpleasant sensation during the collection of freshly made dog faeces can often lead to some owners risking possible fines by leaving the mess in-situ. Thirdly, some owners leave the collected faeces near the start of a walk or outing for disposal upon their return. However, these are sometimes forgotten, often resulting in plastic bags of dog faeces tied to fences, trees or the like.

It is an object of the present invention to reduce or substantially obviate the aforementioned problems.

According to the present invention, and in accordance with a first aspect, there is provided a biological waste collection device comprising: a primary pliantly-flexible appendage receiver for receiving grasping means when collecting biological waste for disposal; the primary pliantly-flexible appendage receiver having a first leading edge and a first trailing edge, and a first receiving area and a second receiving area defined at least in part by the first leading edge and the first trailing edge; the said first leading edge being closed and the said first trailing edge defining at least in part a first access opening; a secondary pliantly-flexible appendage receiver having a second trailing edge and a second leading edge; the said second trailing edge being closed and the said second leading edge defining at least in part a second access opening; and the second leading edge of the secondary pliantly-flexible appendage receiver being on or at the second receiving area of the primary pliantly-flexible appendage receiver in an inverted and reversed relationship relative to the primary pliantly-flexible appendage receiver; the second leading edge extending across the entire or substantially entire lateral extent of the primary pliantly-flexible appendage receiver; the second leading edge forming a hinge, so that the secondary pliantly-flexible appendage receiver can be pivoted over the primary pliantly-flexible appendage receiver to secondarily enclose the biological waste.

Such a biological waste collection device simplifies the double bagging of pet waste which is generally considered good practice, whereby the waste inside the secondary pliantly-flexible appendage receiver is also enclosed or substantially enclosed by the primary pliantly-flexible appendage receiver. Additionally, such a device negates the need to turn any part of the device inside-out, which can be a fiddly process and often an unpleasant one.

Optionally, the hinge is located at or between the first trailing edge and a laterally-extending midline of the second receiving area. Locating the interconnecting hinge closer to the first trailing edge of the primary pliantly-flexible appendage receiver compared to that of the first leading edge optimises the effective double bagging of the said biological waste.

Beneficially, the primary pliantly-flexible appendage receiver and the secondary pliantly-flexible appendage receiver may be contiguously interconnected. Alternatively, the hinge may be adjacent, or substantially at, the first trailing edge. By the first and secondary pliantly-flexible appendage receivers sharing or substantially sharing a common border, preferably, that of the first trailing edge and the second leading edge, it helps ensure suitable double bagging whilst also minimising the material required to produce the biological waste collection device.

Preferably, the secondary pliantly-flexible appendage receiver may be dimensionally larger than the primary pliantly-flexible appendage receiver. In some instances, this may be realised by the secondary pliantly-flexible appendage receiver including gussets at lateral edges. This can allow the secondary pliantly-flexible appendage receiver to more easily encompass the primary pliantly-flexible appendage receiver.

In some cases, the primary pliantly-flexible appendage receiver is tapered towards the first leading edge. Additionally or alternatively, the secondary pliantly-flexible appendage receiver is tapered towards the second trailing edge. Tapering towards the first leading edge and/or the second trailing edge can afford the first and second access openings to be comparatively larger in cross-section compared to the rest of the primary and secondary pliantly-flexible appendage receivers, respectively. This allows the user to more easily insert their hand into the primary pliantly-flexible appendage receiver and/or allows the primary pliantly-flexible appendage receiver to be more readily receivable through the second access opening.

Optionally, the primary pliantly-flexible appendage receiver is rounded towards the first leading edge. Additionally or alternatively, the second pliantly-flexible appendage receiver is rounded towards the second trailing edge. Rounding of the respective edges can minimise the number of possible weak points in the biological waste collection device, minimising the risk of possible egress of the collected biological waste.

The primary pliantly-flexible appendage receiver may be tapered towards the first trailing edge. Additionally or alternatively, the secondary pliantly-flexible appendage receiver may be tapered towards the second leading edge. Tapering towards the respective access openings can help reduce the risk of possible direct contact with and/or egress of the biological waste after collection.

Beneficially, the first receiving area includes a plurality of biasing elements. This can allow the first receiving area, in use, to preferentially conform to the user's hand. This can have the effect of the device being more readily able to accept the said biological waste that is to be collected. It is also envisaged that the second receiving area and the second pliantly-flexible appendage receiver may also include such biasing elements.

Preferentially, the first receiving area may include an absorbent element. Likewise, the second receiving area and/or the secondary pliantly-flexible appendage receiver may also include absorbent elements. This can help the collection of certain types of biological waste and in some cases, help minimise the risk of possible egress once the biological waste has been secondarily enclosed.

Preferably, the secondary pliantly-flexible appendage receiver is dimensionally larger than the primary pliantly-flexible appendage receiver. This allows the primary pliantly-flexible appendage receiver to be more readily receivable by the second pliantly-flexible appendage receiver.

Advantageously, the biological waste collection device can be constructed from a single shape-net. This can reduce manufacturing costs and provide the user with the option of assembling the device themselves. Furthermore, use of a single shape-net can allow for effective double layering of the primary and secondary appendage receivers whilst also minimising the number of seams and thus, possible weak points of the device.

Beneficially, the second access opening may include a closure element. Such closure elements may include adhesive strips, adhesive tabs, ties, zip mechanisms, or the like. The closure element may also include a sealing element. This can help contain the biological waste that has been collected, prior to finding an appropriate disposal option.

According to a second aspect of the invention there is provided a biological waste collection device comprising: a primary pliantly-flexible appendage receiver for receiving grasping means when collecting biological waste for disposal; the primary pliantly-flexible appendage receiver having a leading edge, a trailing edge, and a biological-waste receiving area therebetween; the said leading edge being closed, and the said trailing edge being open which defines at least in part a first access opening; a secondary pliantly-flexible appendage receiver having a second access opening which is at least substantially contiguously interconnected at or adjacent to the first access opening in an inverted and reversed relationship relative to the primary pliantly-flexible appendage receiver; so that the secondary pliantly-flexible appendage receiver can be pivoted over the primary pliantly-flexible appendage receiver to secondarily enclose the biological waste.

According to a third aspect of the invention, there is provided a collection device comprising: a primary pliantly-flexible appendage receiver for receiving grasping means; the primary pliantly-flexible appendage receiver having a first leading edge, a first trailing edge, a first receiving area therebetween and a second receiving area therebetween; the said first leading edge being closed and the said first trailing edge defining at least in part a first access opening; a secondary pliantly-flexible appendage receiver having a second trailing edge and a second leading edge; the said second trailing edge being closed and the said second leading edge defining at least in part a second access opening; and the second leading edge of the secondary pliantly-flexible appendage receiver being on or at the second receiving area of the primary pliantly-flexible appendage in an inverted and reversed relationship relative to the primary pliantly-flexible appendage receiver; the second leading edge forming a pivot, so that the secondary pliantly-flexible appendage receiver can be pivoted over the primary pliantly-flexible appendage receiver to enclose the pliantly-flexible appendage receiver.

According to a fourth aspect of the invention, there is provided a method of collecting biological waste and simplifying secondary enclosure in preparation for disposal using a biological waste collection device, preferably in accordance with the first aspect of the invention, the method comprising the steps of: a) providing primary and secondary pliantly-flexible appendage receivers which are connected in an inverted and reversed relationship to each other; b) collecting biological waste with the primary pliantly-flexible appendage receiver; and c) pivoting the secondary pliantly-flexible appendage receiver to enclose the primary pliantly-flexible appendage receiver along with the biological waste. Such a method affords a more efficient way of effectively double bagging biological waste. Additionally, it can also negate the need to turn any part of the device inside-out, which can be a fiddley process, streamlining what is an unpleasant experience.

A method of collecting and enclosing such biological waste ready for disposal can be further aided by the inclusion and operation of a closure element which may also include a sealing element. Particularly useful for when a suitable disposal option cannot be found in a timely manner.

Preferably, the method may include assembly of the biological waste collection device from the single shape-net. This can help reduce manufacturing costs and the subsequent cost of the resulting product, important for such a disposable item.

For a better understanding of the present invention, and to show more clearly how it may be carried into effect, reference will now be made by way of example only to the accompanying drawings, in which:

FIG. 1 shows a side view of a biological waste collection device in accordance with first, second and third aspects of the invention, in which a primary pliantly-flexible appendage receiver is arranged in an inverted and reversed relationship to a secondary pliantly-flexible appendage receiver;

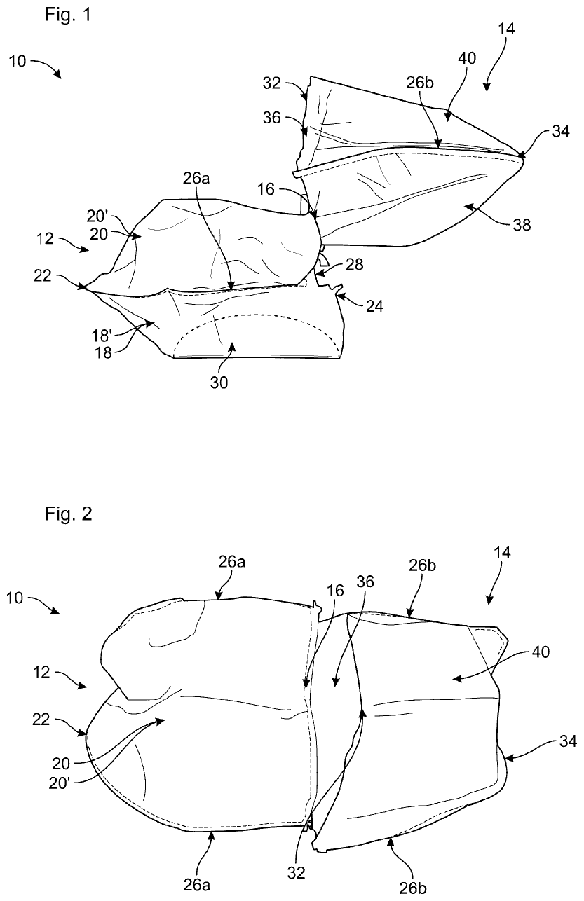

FIG. 2 shows a top plan view of the biological waste collection device as shown in FIG. 1, in which a second access opening is visible;

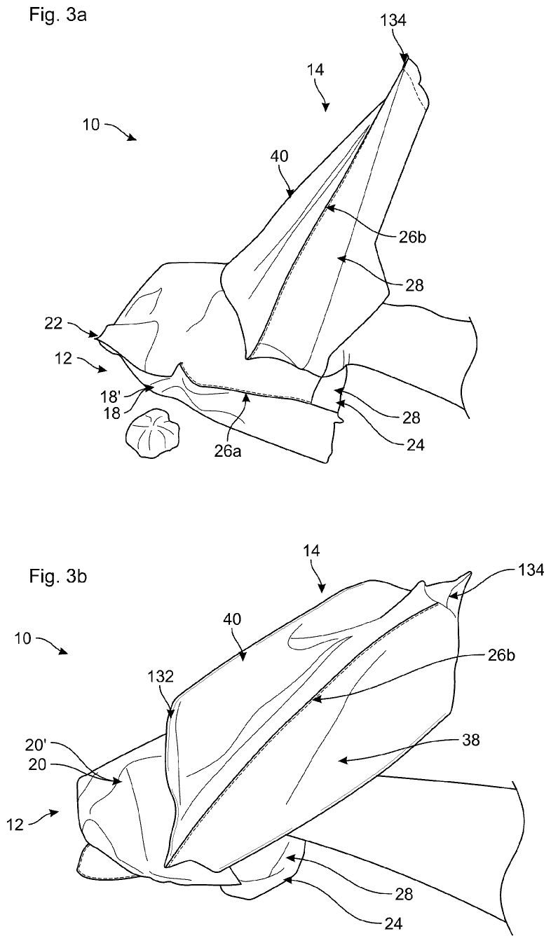

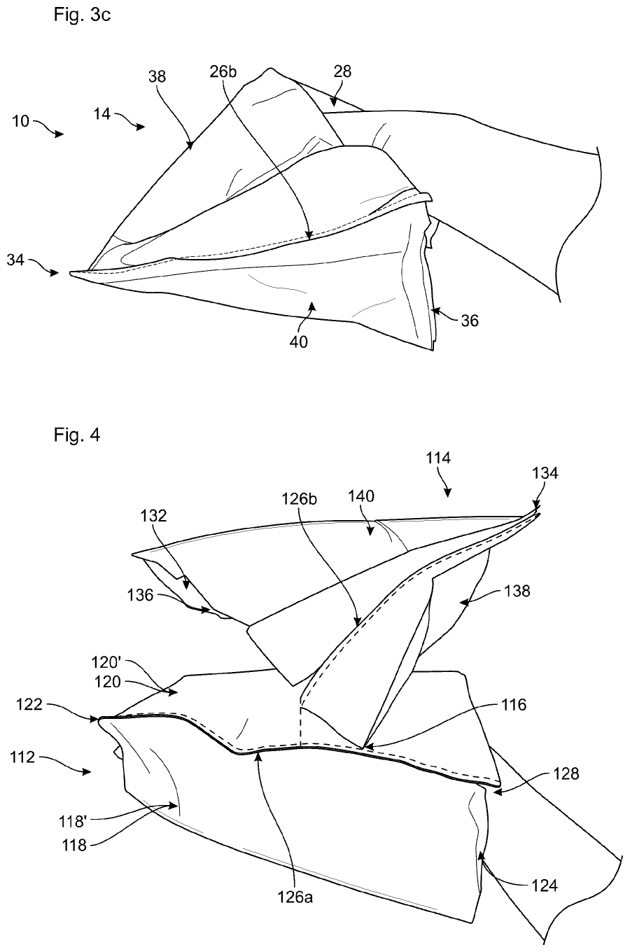

FIG. 3a shows in use the biological waste collection device as first shown in FIG. 1, in which an appendage is inserted into the primary pliantly-flexible appendage receiver and a representation of biological waste to be collected is visible;

FIG. 3b shows in use the biological waste collection device as first shown in FIG. 1, in which the biological waste, as shown in FIG. 3a, is received by a primary receiving area of the primary pliantly-flexible appendage receiver;

FIG. 3c shows in use the biological waste collection device as first shown in FIG. 1, in which the secondary pliantly-flexible appendage receiver is pivoted over the primary pliantly-flexible appendage receiver to secondarily enclose the biological waste;

FIG. 4 shows a side view of another embodiment of the biological waste collection device in accordance with the first and third aspects of the invention in which an appendage is inserted into the primary pliantly-flexible appendage receiver;

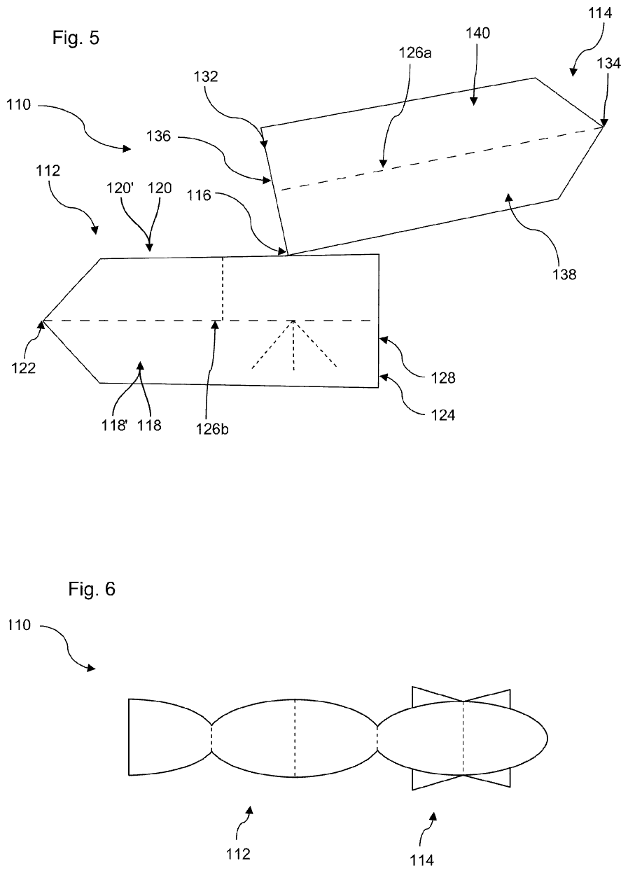

FIG. 5 shows a line drawing of a side view of the biological waste collection device as shown in FIG. 4; and

FIG. 6 shows a line drawing of a shape-net, which once assembled forms the biological waste collection device first shown in FIG. 4.

Referring firstly to FIGS. 1 and 2, there is shown an embodiment of a biological waste collection device 10 having a primary pliantly-flexible appendage receiver 12 and a secondary pliantly-flexible appendage receiver 14. The primary and secondary pliantly-flexible appendage receivers 12, 14 are arranged in an inverted and reversed relationship and are interconnected about a hinge 16.

The primary pliantly-flexible appendage receiver 12 has a first receiving surface 18, a second receiving surface 20 connected to the first receiving surface 18, a first leading edge 22 and an opposing first trailing edge 24. Adjacent to the first leading edge 22 and the first trailing edge 24 are two opposing lateral or side edges 26a, such that the first leading edge 22 and first trailing edge 24 are separated by the two said lateral or side edges 26a. The first and second receiving surfaces 18, 20 are connected at one end such that the first leading edge 22 is effectively closed and are not connected at the opposing end such that the first trailing edge 24 is effectively open. The open first trailing edge 24 forms, or substantially forms, a first access opening 28. The first and second receiving surfaces 18, 20 are also connected at opposing sides such that the two opposing lateral edges 26a are effectively closed.

The primary pliantly-flexible appendage receiver 12 also has a first receiving area 18′ and a second receiving area 20′. The first and second receiving areas 18′, 20′, in this instance, are defined by the first and second receiving surfaces 18, 20 respectively, and the first leading edge 22, the first trailing edge 24 and the two lateral or side edges 26a. The first receiving area 18′ in this particular instance also presents an absorbent element 30, preferably positioned on or formed as part of the first receiving surface 18. Together, the first and second receiving surfaces 18, 20 define a first volume therein to receive a user's hand via the first access opening 28, in use.

The secondary pliantly-flexible appendage receiver 14 has a third receiving surface 38, a fourth receiving surface 40 connected to the third receiving surface 38, a second leading edge 32 and an opposing second trailing edge 34. The third and fourth receiving surfaces 38, 40 are not connected at one end such that the second leading edge 32 is effectively open and are connected at the opposing end such that the second trailing edge 34 is effectively closed. Adjacent to the second leading edge 32 and second trailing edge 34 are two opposing lateral or side edges 26b, such that the second leading edge 32 and second trailing edge 34 are in a spaced apart arrangement, the two said lateral or side edges 26b therebetween. The open second leading edge 32 defines, or substantially defines, a second access opening 36. Together, the third and fourth receiving surfaces 38, 40 define a second volume therein to receive the primary pliantly-flexible appendage receiver 12 via the second access opening 36, in use.

The second leading edge 32 of the secondary pliantly-flexible appendage receiver 14 is interconnected with the primary pliantly-flexible appendage receiver 12 at the first trailing edge 24 of the second receiving area 20′ of the second receiving surface 20, forming the hinge 16 in this particular embodiment. The interconnection is facilitated by a seam, whereby the primary and secondary pliantly-flexible appendage receivers 12, 14 are sown together along the entire lateral extent so that they are effectively contiguously interconnected at or adjacent to the first access opening 28.

As best shown in FIG. 2, the primary pliantly-flexible appendage receiver 12 in this instance is rounded towards the first leading edge 22. The secondary pliantly-flexible appendage receiver 14 is tapered towards the second trailing edge 34.

The biological waste collection device 10 and any part thereof may comprise or be formed from paper, grease proof paper, card, polymer, composite, other synthetic, or indeed one or more naturally occurring materials, textile etc, or any combination thereof. The biological waste collection device 10 may be at least in part opaque or substantially opaque. Preferably, the biological waste collection device 10 is made from a biodegradable and/or recycled material.

Referring now to FIGS. 3a to 3c, in use a user's hand is inserted into the primary pliantly-flexible appendage receiver 12 via the first access opening 28. The user can then grasp biological waste to be collected without direct contact. Grasping of the biological waste allows it to be enclosed or substantially enclosed by the first receiving area 18′. The user can then pivot the secondary pliantly-flexible appendage receiver 14 over the primary pliantly-flexible appendage receiver 12, secondarily enclosing the biological waste. The user can then remove their hand and close, or substantially close the second access opening 36. The collected waste within the biological waste collection device 10 can then be disposed of appropriately. Such a process allows for efficient and effective double bagging of said biological waste without the need to turn any part of the device inside out.

Whilst the primary pliantly-flexible appendage receiver 12 is primarily for receiving a user's hand, it is appreciated that it may also receive another grasping means or grasping element such as a mechanically operated grasper. Similarly, the primary pliantly-flexible appendage receiver 12 may also be for receiving a scoop.

Whilst the first receiving area 18′ has been described above as the area which first receives the biological waste, it is appreciated that this could also be the second receiving area 20′. In this case, the secondary pliantly-flexible appendage receiver 14 is pivoted from underneath the user's hand when in use, to come up over the primary pliantly-flexible appendage receiver 12 and secondarily enclose the biological waste. Referring now to FIGS. 4 and 5, there is shown a second embodiment in accordance with the first and third aspect of the invention. For similar or identical features in FIGS. 4 to 6 as those presented in FIGS. 1 to 3c, the reference numerals from FIGS. 1 to 3c have been utilised with 100 added. Description of similar or identical features have been omitted for conciseness.

In this case, the secondary pliantly-flexible appendage receiver 114 is connected to the second receiving area 120′ between the first trailing edge 124 and a laterally-extending midline of the second receiving area 120′. The two lateral or side edges 126b of the secondary pliantly-flexible appendage receiver 114 include gussets. The first receiving area 118′ also includes biasing means or biasing elements in the form of preformed folds and/or stitching.

The biological waste collection device 110 in this particular embodiment is formed from a single shape-net, as shown in FIG. 6. Thus, the hinge 116 in this instance is a fold, whereby the primary and secondary pliantly-flexible appendage receivers 112, 114 are integrally formed. The biological waste collection device 110, formed from the single shape-net in this instance is sown together. However, it is appreciated that adhesives may be utilised in combination with or instead of seams which are sown.

In use, a user's hand is inserted into the primary pliantly-flexible appendage receiver 112, and the biological waste is then enclosed or substantially enclosed within the first receiving area 118′. The biasing means present in this embodiment allow the first receiving area 118′ to preferentially buckle at these points, so as to conform to the user's hand during the grasping process.

The secondary pliantly-flexible appendage receiver 114 can then be pivoted over the primary pliantly-flexible appendage receiver 112. In this instance, the secondary pliantly-flexible appendage receiver 114 pivots over and beyond the first access opening 128 due to the pivot being located between the first trailing edge 124 and a laterally-extending midline of the second receiving area 120′. The gussets allow for the secondary pliantly-flexible appendage receiver 114 to be dimensionally larger than the primary pliantly-flexible appendage receiver 112 to more easily enclose the primary pliantly-flexible appendage receiver 112 in use.

Once the biological waste and the primary pliantly-flexible appendage receiver 112 is wholly encompassed within the secondary pliantly-flexible appendage receiver 114, the second access opening 136 can then be closed.

In an alternative embodiment, the primary pliantly-flexible appendage receiver of the biological waste collection device may simply have a leading edge, a trailing edge, and a biological-waste receiving area therebetween. A first access opening is then similarly defined by the open trailing edge. The secondary pliantly-flexible appendage receiver of this alternative embodiment has a second access opening which is at least substantially contiguously interconnected at or adjacent to the first access opening in an inverted and reversed relationship relative to the primary pliantly-flexible appendage receiver, so that the secondary pliantly-flexible appendage receiver can be pivoted over the primary pliantly-flexible appendage receiver to secondarily enclose the biological waste.

Whilst the embodiment as shown in FIGS. 1 to 3c demonstrates rounding of the primary pliantly-flexible appendage receiver 12 towards the first leading edge 22, it is appreciated that the primary pliantly-flexible appendage receiver may be, or may also be, tapered towards the first leading edge. Likewise, the primary pliantly-flexible appendage receiver may be rounded or tapered towards the first trailing edge. As yet another alternative, a portion of the primary pliantly-flexible appendage receiver adjacent to the first leading edge and/or the first trailing edge may be rounded or tapered.

Similarly, whilst the secondary pliantly-flexible appendage receiver 14 presents tapering towards the second trailing edge 34, as best shown in FIG. 2, it is appreciated that the secondary pliantly-flexible appendage receiver may be, or may also be, rounded towards the second trailing edge. Likewise, the secondary pliantly-flexible appendage receiver may be rounded or tapered towards the second leading edge. As yet another alternative, a portion of the second pliantly-flexible appendage receiver adjacent to the second trailing edge and/or the second leading edge may be rounded or tapered.

The embodiment as shown in FIGS. 4 to 6, includes gussets at lateral or side edges 126b of the secondary pliantly-flexible appendage receiver 114. It is envisaged that gussets may only be included at one lateral or side edge of the secondary pliantly-flexible appendage receiver. Similarly a gusset, or gussets, may be included in the primary pliantly-flexible appendage receiver. Alternatively or additionally, gussets may also be included at the first leading edge 122 and/or second trailing edge 134.

The primary and secondary pliantly-flexible appendage receivers 112, 114 may also include more than one layer of material. This is demonstrated in FIG. 6, whereby the shape-net affords the primary pliantly-flexible appendage receiver 112 two layers. In the case where the primary and/or secondary pliantly-flexible appendage receivers 112, 114 include double layering, the absorbent element may be disposed between the two said layers. The absorbent element in this case may simply be tissue paper but may also be cotton, a layer of sodium polyacrylate or other suitable absorbent material, and/or any combination thereof with suitable absorbency properties.

In some instances, the primary pliantly-flexible appendage receiver is similar or identical to the secondary pliantly-flexible appendage receiver. In these cases, the primary pliantly-flexible appendage receiver may be interchangeable with the secondary pliantly-flexible appendage receiver.

In other cases, the secondary pliantly-flexible appendage receiver may be dimensionally larger than the primary pliantly-flexible appendage receiver. This may be afforded by a greater length and/or width of the secondary pliantly-flexible appendage receiver compared to that of the primary pliantly-flexible appendage receiver.

The two embodiments, as shown in the drawings, demonstrate that the hinge 16, 116 extends the entire or substantially entire lateral extent of the primary pliantly-flexible appendage receiver 12, 112. In either instance, the hinge 16, 116 extends along the first trailing edge 24, 124 of the second receiving surface 20, 120 by virtue of primary and secondary pliantly-flexible appendage receivers 12, 112, 14, 114 being either sown together or formed from a single shape-net. However, in other instances the hinge may not extend the entire extent. Discontinuity can be achieved in a number of ways, including by perforation. Perforation can afford preferential buckling of the hinge. Additionally, the secondary pliantly-flexible appendage receiver may be more easily detached from the primary pliantly-flexible appendage receiver if the user so wishes. Alternatively, discontinuity may also be achieved by one or more hinge points. For example, two hinges could be located adjacent to the lateral or side edges of the primary and secondary pliantly-flexible appendage receivers. Likewise, the hinge, or hinges, may also be located inboard of the said lateral or side edges. Additionally, the hinge, or hinges, may also be reinforced. Such reinforcement may simply be additional layers of material at or on the hinge.

The second access opening 36, 136 of the secondary pliantly-flexible appendage receiver 14, 114 may include a closure element. The closure element in the two embodiments shown in the drawings include a folding mechanism at or adjacent to the inverted 36, 136. In other instances, this may be facilitated by folds or biasing means such as stitches parallel or substantially parallel to the second access opening.

The closure element may include tabs at either side of the second access opening and at or adjacent to the two lateral or side edges of the secondary pliantly-flexible appendage receiver. In use, once the second access opening has been folded, the tabs can be tied together. Alternatively, the aforementioned tabs may include an adhesive tab, allowing them to be adhered together. In other instances, an adhesive strip may be included which may be parallel or substantially parallel to the second access opening. In this case, the second access opening, once folded can be adhered along the strip, closing the second access opening.

Although this present invention relates to a collection device for biological waste, it is appreciated that such a collection device may be used for the collection of any kind of waste, food and/or material. For example, although preferably directed to the collection of excreted matter, such as animal droppings, including but not limited to dog and/or cat poo, the collection device may be utilised for the collection of other discharged matter, such as human, baby or child waste, human or animal vomit, containers such as food trays and cartons, cigarette butts, discarded gum, and/or used drug paraphernalia such as syringe bodies and/or needles.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of example only, and various changes and modifications will be apparent to persons skilled in the art without departing from the scope of the present invention as defined by the appended claims.

1. A biological waste collection device comprising:
a primary pliantly-flexible appendage receiver configured to receive a grasper when collecting biological waste to be disposed;
the primary pliantly-flexible appendage receiver having a first leading edge and a first trailing edge, and a first receiving area; and a second receiving area defined at least in part by the first leading edge and the first trailing edge;
the said first leading edge being closed and the said first trailing edge defining at least in part a first access opening;
a secondary pliantly-flexible appendage receiver having a second trailing edge and a second leading edge;
the said second trailing edge being closed and the said second leading edge defining at least in part a second access opening; and
the second leading edge of the secondary pliantly-flexible appendage receiver being on or at the second receiving area of the primary pliantly-flexible appendage receiver in an inverted and reversed relationship relative to the primary pliantly-flexible appendage receiver;
the second leading edge extending across the entire or substantially entire lateral extent of the primary pliantly-flexible appendage receiver;
the second leading edge forming a hinge so that the secondary pliantly-flexible appendage receiver is configured to pivot over the primary pliantly-flexible appendage receiver to secondarily enclose the biological waste.

2. The biological waste collection device as claimed in claim 1, wherein the hinge is located at or between the first trailing edge and a laterally-extending midline of the second receiving area.

3. The biological waste collection device as claimed in claim 2, wherein the primary pliantly-flexible appendage receiver and the secondary pliantly-flexible appendage receiver are contiguously interconnected.

4. The biological waste collection device as claimed in claim 1, wherein the hinge is adjacent or substantially at the first trailing edge.

5. The biological waste collection device as claimed in claim 1, wherein the secondary pliantly-flexible appendage receiver includes gussets at lateral edges.

6. The biological waste collection device as claimed in claim 1, wherein the primary pliantly-flexible appendage receiver is at least one of the following: tapered towards the first leading edge rounded towards the first leading edge.

7. (canceled)

8. The biological waste collection device as claimed in claim 1, wherein the primary pliantly-flexible appendage receiver is tapered towards the first trailing edge.

9. The biological waste collection device as claimed in claim 1, wherein the secondary pliantly-flexible appendage receiver is one of the following: tapered towards the second leading edge-; tapered towards the second trailing edge.

10. (canceled)

11. The biological waste collection device as claimed in claim 1, wherein the first receiving area includes a plurality of biasing elements.

12. The biological waste collection device as claimed claim 1, wherein the first receiving area includes an absorbent.

13. The biological waste collection device as claimed in claim 1, wherein the secondary pliantly-flexible appendage receiver is dimensionally larger than the primary pliantly-flexible appendage receiver.

14. The biological waste collection device as claimed in claim 1, wherein the biological waste collection device is constructed from a single shape-net.

15. The biological waste collection device as claimed in claim 1, wherein the second access opening includes a closure element.

16. The biological waste collection device as claimed in claim 15, wherein the closure element includes a sealing element.

17. A biological waste collection device comprising:
a primary pliantly-flexible appendage receiver configured to receive a grasper when collecting biological waste to be disposed;
the primary pliantly-flexible appendage receiver having a leading edge, a trailing edge, and a biological-waste receiving area therebetween;
the said leading edge being closed, and the said trailing edge being open which defines at least in part a first access opening;
a secondary pliantly-flexible appendage receiver having a second access opening which is at least substantially contiguously interconnected at or adjacent to the first access opening in an inverted and reversed relationship relative to the primary pliantly-flexible appendage receiver;
so that the secondary pliantly-flexible appendage receiver is configured to pivot over the primary pliantly-flexible appendage receiver to secondarily enclose the biological waste.

18. A collection device comprising:
a primary pliantly-flexible appendage receiver configured to receive a grasper;
the primary pliantly-flexible appendage receiver having a first leading edge a first trailing edge a first receiving area therebetween and a second receiving area therebetween;
the said first leading edge being closed and the said first trailing edge defining at least in part a first access opening;
a secondary pliantly-flexible appendage receiver having a second trailing edge and a second leading edge;
the said second trailing edge being closed and the said second leading edge defining at least in part a second access opening; and
the second leading edge of the secondary pliantly-flexible appendage receiver being on or at the second receiving area of the primary pliantly-flexible appendage receiver in an inverted and reversed relationship relative to the primary pliantly-flexible appendage receiver;
the second leading edge forming a pivot, so that the secondary pliantly-flexible appendage receiver is configured to pivot over the primary pliantly-flexible appendage receiver to enclose the primary pliantly-flexible appendage receiver.

19. A method of collecting biological waste and simplifying secondary enclosure in preparation for disposal using a biological waste collection device as claimed in claim 1, the method comprising the steps of:
a) providing primary and secondary pliantly-flexible appendage receivers which are connected in an inverted and reversed relationship to each other;
b) collecting biological waste with the primary pliantly-flexible appendage receiver; and
c) pivoting the secondary pliantly-flexible appendage receiver to enclose the primary pliantly-flexible appendage receiver along with the biological waste.

20. The method of collecting biological waste as claimed in claim 19, further including a step d) subsequent to step c), the step d) including closing a second access opening of the secondary pliantly-flexible appendage receiver using a closure element.

21. The method of collecting biological waste as claimed in claim 20, where in step d) further includes sealing the second access opening.

22. The method of collecting biological waste as claimed in claim 19, wherein step a) includes assembling the primary and secondary pliantly-flexible appendage receivers from a single shape-net.
